(19) United States
(12) Patent Application Publication
(10) Pub. No.: US 2009/0001154 A1
(43) Pub. Date: Jan. 1, 2009

(54) IMAGE FORMING APPARATUS AND METHOD

(76) Inventor: Weibo Wang, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/854,057

(22) Filed: Sep. 12, 2007

(30) Foreign Application Priority Data
Sep. 13, 2006 (JP) 2006248216

(51) Int. Cl. G06F 17/00

(52) U.S. Cl. 235/375

(57) ABSTRACT

An image forming apparatus connected to a network including a reading device configured to read a document having ID data; a storage device configured to store a document data that is transmitted by the reading device; an analyzing device configured to analyze the document data and to determine an image forming apparatus that formed the document using the ID data; a communication device configured to transmit the ID data to the image forming apparatus found by the analyzing device; and an image generating device configured to generate the document data on a media when said communication device receives an authorization to copy sent by the image forming apparatus that is found by the analyzing device.

### CROSS-REFERENCE OF APPLICATIONS

The present application claims priority to corresponding Japanese Application No. 2006-248216, filed on Sep. 13, 2006, the entire contents of which are hereby incorporated by reference.

### BACKGROUND OF THE INVENTION

1. Field of the Invention

The present invention generally relates to management of information security, and particularly to a document security managing technique. The present invention also relates to an image generating method, device, and system including an image forming apparatus utilizing an image reader. More particularly, the invention relates to a technique for inhibiting the unauthorized copying of a document wherein the unauthorized copying is inhibited when the document image is read by a copying machine.

2. Discussion of the Background

In recent years, the problem of how to secure information resources has been increasing in concern. In particular, it is important to secure information resources that have secret or sensitive information including, for example, trade secrets, patent information, etc. But a complete prohibition of copying documents of this nature would prevent copying of those documents when needed.

Consequently, a number of techniques have been suggested for managing systems including image forming apparatuses, servers, and microcomputers, such as PCs wherein the image forming apparatus has a reading device. When the reading device reads a document that has ID data, the image forming apparatus sends the ID data and an input password. The server has a list of ID data and corresponding passwords. The server checks the received ID data and password provided on the list. If there is a match, the user can copy the document. On the other hand, if there is no match, then the user can't copy the document.

Techniques of this nature require a server to implement the password checking process. Consequently, these techniques are inflexible.

### SUMMARY OF THE INVENTION

The present invention provides an image forming apparatus and method of forming an image which addresses, among other things, the just described technique using a password checking system.

In one embodiment, an image forming apparatus is connected to a network, including, a reading device configured to read a document that has ID data, an analyzing device configured to analyze document data of the document and to determine an image forming apparatus that formed the document using the ID data; a communication device configured to transmit the ID data to an image forming apparatus found by the analyzing device, and an image generating device configured to generate the document data on a media (e.g., paper) when the communication device receives from the found image forming apparatus authorization to copy.

The present invention additionally provides a method for forming an image using an image forming apparatus, including, reading a document that has ID data, analyzing document data of the document, determining an image forming apparatus that formed the document using the ID data, transmitting the ID data to the found image forming apparatus, generating the document data on a media when the image forming apparatus receives from the found image forming apparatus authorization to copy.

### BRIEF DESCRIPTION OF THE DRAWINGS

FIG. 1 illustrates an image forming system including an image forming apparatus according to the present invention;

FIG. 2 is a block diagram illustrating an embodiment of the image forming apparatus according to the present invention;

FIG. 3 is an example of a user display image of the operating device or display apparatus connected to a personal computer according to the present invention;

FIG. 4 is an example of a security data table stored in an image forming apparatus according to the present invention;

FIG. 5A is an example of another security data table stored in an image forming apparatus according to the present invention;

FIG. 5B is an example of another security data table stored in an image forming apparatus according to the present invention;

FIG. 6 is a flow chart illustrating the process for providing an ID on a document according to the present invention;

FIG. 7 is a flow chart illustrating a secure copying procedure according to the present invention; and

FIG. 8 illustrates a screen shot for entering a Document ID for modifying values of a security data table.

### DETAILED DESCRIPTION OF THE INVENTION

In the following, embodiments of the present invention will be described with reference to the accompanying drawings.

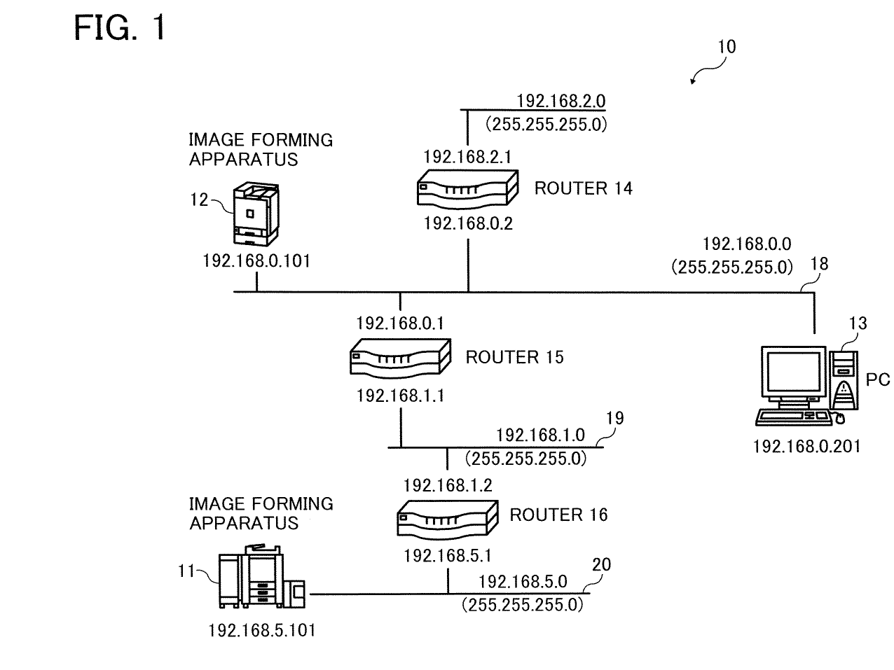

In FIG. 1, an image forming system 10 includes an image forming apparatus 11 which functions as a printer, a copier and a scanner. A second image forming apparatus 12, a personal computer 13, a first router 14, a second router 15, a third router 16 and a network 17 (e.g., a local area network) for interconnecting these apparatuses are also provided.

FIG. 1 also identifies example IP addresses for each apparatus. The IP address of the image forming apparatus 11 is 192.168.5.101. The IP address of the second image forming apparatus 12 is 192.168.0.101. The IP address of the personal computer 13 is 192.168.0.201. The IP addresses of the first router 14 are 192.168.2.1 and 192.168.0.2. The IP addresses of the second router 15 are 192.168.0.1 and 192.168.1.1. The IP addresses of the third router 16 are 192.168.1.2 and 192.168.5.1. Therefore, the image apparatuses connected to the network 17 are visible to the image forming system 10.

FIG. 1 also reflects that the network 17 has several divisions as described below. The second image forming apparatus 12, the personal computer 13, the first router 14, and the second router 15 are connected to first network segment 18 (192.168.0.0). The second router 15 and the third router 16 are connected to a second network segment 19 (192.168.1.0), and the image forming apparatus 11 and the third router 16 are connected to a third network segment 20 (192.168.5.101). IP address (255.255.255.0) is a subnet mask.

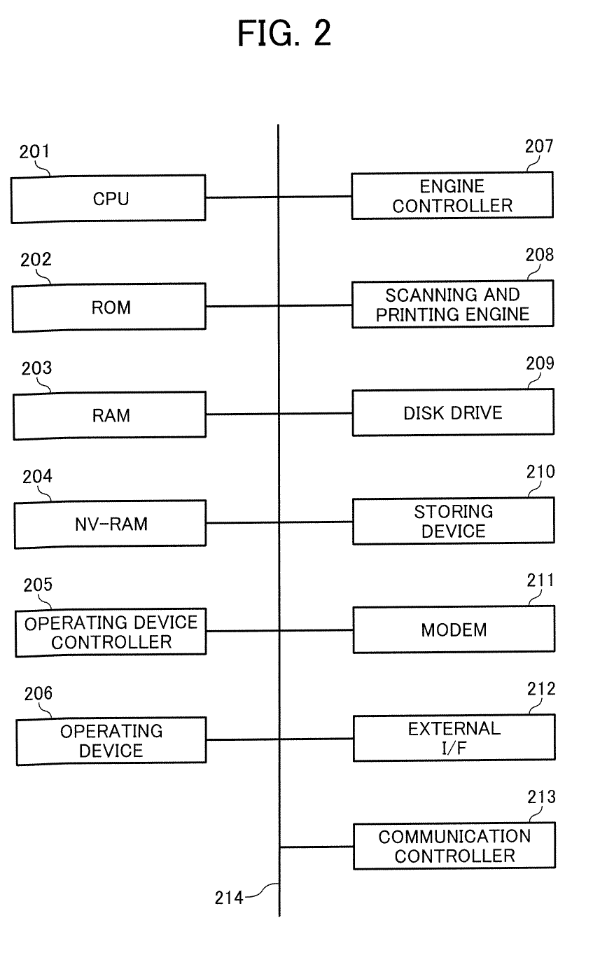

FIG. 2 illustrates that the image forming apparatus 11 and the second image forming apparatus each 12 have a CPU 201, ROM 202, RAM 203, NV-RAM 204, a communication controller 205, an operating device 206, a controller for an engine 207, an engine for scanning and printing 208, a disc driver 209, a storage device 210, a modem 211, an external interface 212, and a communication controller 213. These devices are connected by data bus 214. The CPU 201 controls each of these devices.

The ROM 202 stores static data, for example, program code and font data, etc. The RAM is the working memory of the CPU 201 and temporary storage area. The NV-RAM 204 stores data that requires non-volatile storage and firmware. The communication controller 205 and the operating device 206 function as an interface for the user. The engine controller 207 and the scanning and printing engine 208 function as an input and output unit to scan documents and to generate images on a media (e.g., paper). The disc drive 209 and the storage device 210 function to store document data and older versions of firmware, constructing a table of firmware, and the history of changing firmware versions. The modem 211 is connected to a public switched telephone network and is configured to communicate with external apparatuses. The external interface 212 is configured to communicate with external apparatuses by using, for example, a centronics interface and RS232 etc. The communication controller 213 connected to a LAN and is configured to communicate with external apparatuses. All of these devices are connected by a data bus 214.

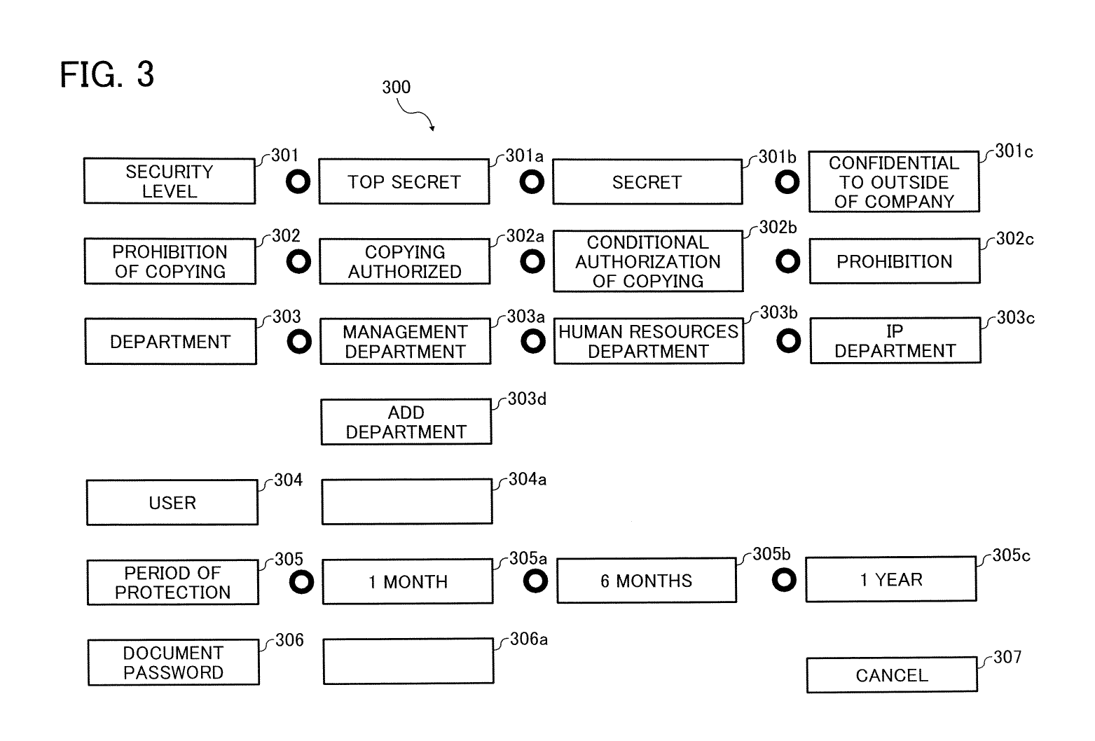

FIG. 3 illustrates that a user is able to set-up a security level of a document 301 and a prohibition level of copying 302. Copying authorization can be provided to a department 303 or to another user. A time period of protection 305 can be defined and a document password 306 can be required. If the user wishes not to establish a security-level for the document, then the user can merely copy or print the document by selecting CANCEL 307.

According to this example embodiment, the security level of document 301 can be set to top secret 301a, secret 301b, or confidential to the outside of the company 301c.

The prohibition level of copying 302 can be set to copying authorized 302a, conditional authorization of copying 302b, and prohibition of copying 302c.

The right to copy can be set by department. For example, the management department 303a may be authorized to copy, the human resource department 303b may be prohibited from copying, and the intellectual property department 303c may have a conditional authorization to copy. New departments 303d may be added. If a user chooses department 303, a department ID is stored in the storage device in the second image forming apparatus. If the user chooses to add department 303d, then the user is able to add the department. The right to copy can be set for each individual user via the user ID instead of through a department wide authorization. The user ID can be entered in input box 304a.

The time period of protection 305 can be set, for example, to 1 month 305a, 6 months 305b, or 1 year 305c. The document password 306 is available for getting a password that is needed when the user wishes to copy the document.

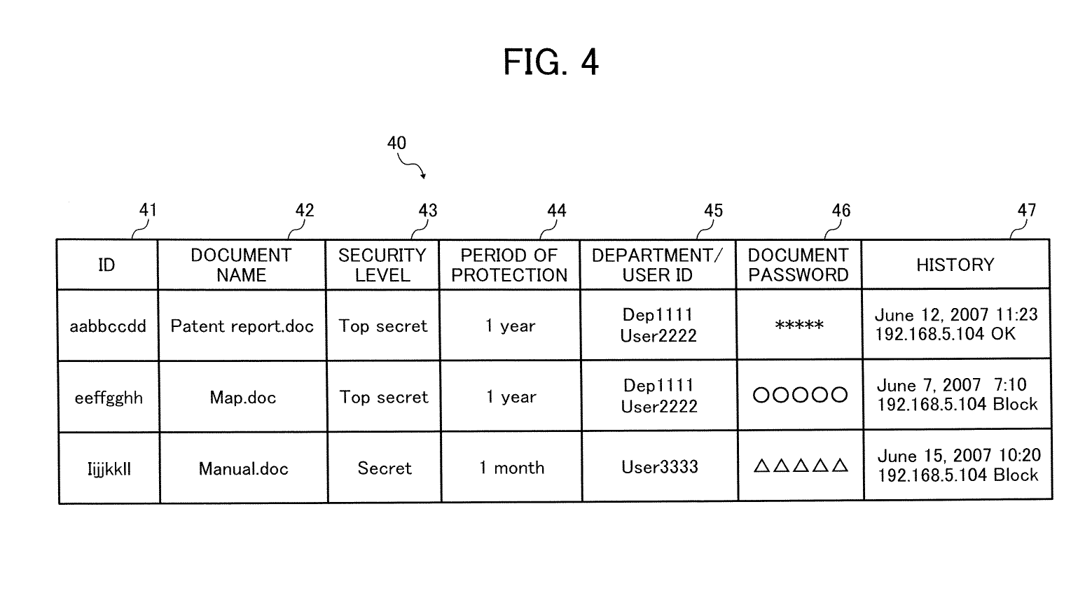

FIG. 4 is an example of the data table stored in the second image forming apparatus 12. The data table 40 includes, for example, a document ID 41, document name 42, a security level 43, a period of protection 44, a department ID or a user ID reflecting a right to copy 45, a document password 46, and a history 47.

The document ID 41 is set by the second image forming apparatus automatically when a user copies or prints a document. The document ID 41 is generated from the second image forming apparatus's data including IP address, MAC address, subnet mask etc.

The document name 42 is set by the user, when the user copies or prints a document, using the operating device 206 or a keyboard or a mouse connected to the personal computer 13. Moreover, the document name 42 is also set by the second image forming apparatus 12 based on metadata of the document when another user prints out the document. The security level 43, the period of protection 44, the department or user ID 45, and the document password 46 are set by the user via the display image 300.

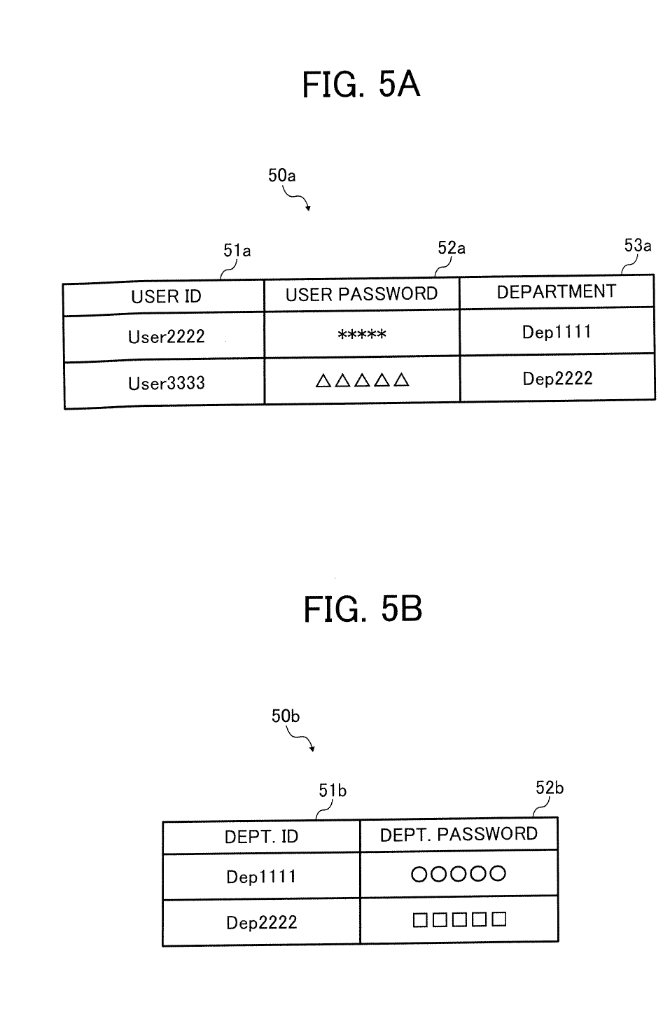

FIG. 5A is an example of another data table stored in the second image forming apparatus 12. This data table is accessed when the user copies the document at the image forming apparatus 11. The data table 50a includes User ID 51a, User password 52a, and the User's department 53a. This data is set by the system manager or the user.

FIG. 5B is an example of another data table stored in the second image forming apparatus 12. This data table is accessed when the user copies the document at the image forming apparatus 11. The data table 50b includes Department ID 51b, and Department password 52b. This data is set by the system manager or user.

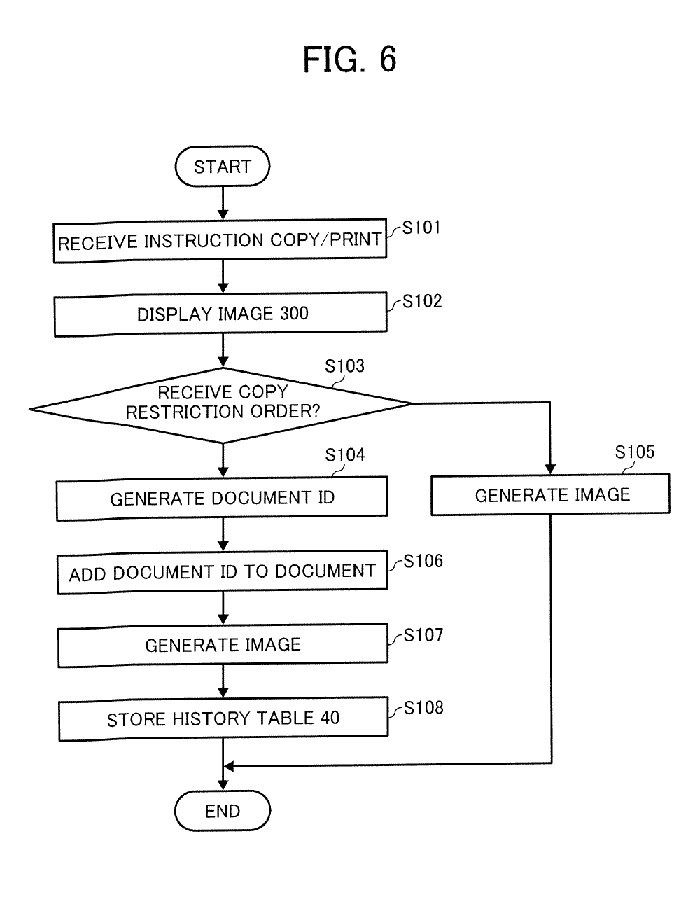

FIG. 6 is a flow chart exemplarily showing the process for generating a document ID using the second image forming apparatus 12.

The second image forming apparatus 12 receives a signal to generate document data on a media (step S101). The second image forming apparatus 12 receives the signal to generate the document via the operating device 206 or the network 17 via the personal computer 13.

The second image forming apparatus 12 displays the display image 300 using, for example, a liquid crystal display, a part of the operating device 206, or sends the display image 300 to the personal computer 13. (step S102)

If the other image forming apparatus 12 receives a copy restriction signal (step S103: YES), the second image forming apparatus 12 generates a document ID based on the IP address, MAC address and subnet mask of the second image forming apparatus 12 (step S104). If the second image forming apparatus 12 doesn't receive a copy restriction signal (step S103: NO), the second image forming apparatus 12 generates the document data on the media, for example, paper (step S105).

The second image forming apparatus 12 adds the document ID data to the document data (step S106). The second image forming apparatus 12 then generates the document data added to the document ID on the media (step S107). Document ID data is added as a two-dimensional code or a digital watermarking etc.

The second image forming apparatus 12 stores the document ID and copy data, set by the user via display image 300, for example, a security level of the document 301 etc., to the history data table 40 (step S108).

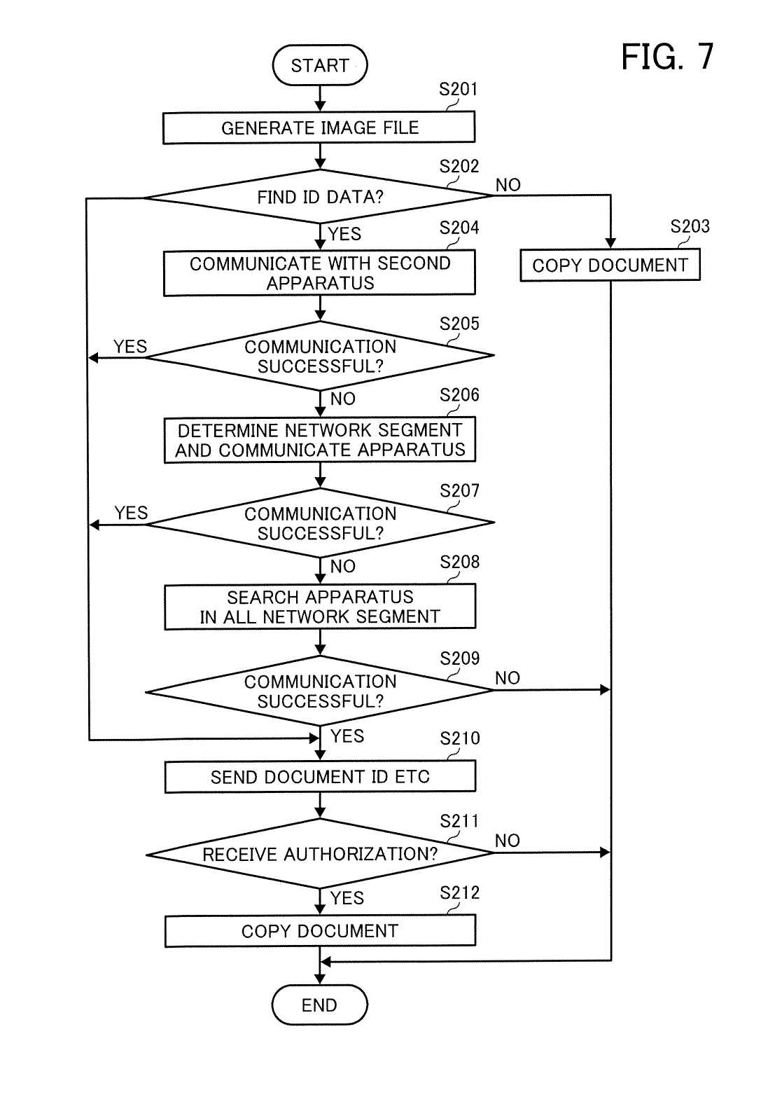

FIG. 7 is a flow chart exemplarily showing a copying procedure of the image forming apparatus 11. The image forming apparatus 11 generates an image file of a document that is read by a reading device. Additionally, the image forming apparatus 11 stores the image file in the storage device 210 (step S201).

The analyzing device of the image forming apparatus 11 analyzes the document file to find the document ID data. If the document file doesn't have the document ID (step S202: NO), then the image forming apparatus copies the document (step S203). If the document file has the document ID (step S202: YES), then the image forming apparatus analyzes the document ID to identify the second image forming apparatus using, for example, it's IP address, MAC address, and subnet mask etc. Additionally, the image forming apparatus communicates with the second image forming apparatus 12 via a predetermined protocol, for example, SNMP or SOAP etc (step S204). More specifically the image forming apparatus 11 sends the document ID to the second image forming apparatus 12.

The image forming apparatus 11 determines whether communication to the second image forming apparatus was a success or failure. If the image forming apparatus 11 determines that the communication was a failure (step S205: NO), then the image forming apparatus 11 determines which network segment is connected to the second image forming apparatus 12 using the second image forming apparatus's IP address and subnet mask. The image forming apparatus 11 then sends the document ID to the second image forming apparatus using the predetermined protocol (step S206). If the image forming apparatus 11 determines that the communication was a success (step S205: YES), then the image forming apparatus 11 processes step S210 as follows.

The image forming apparatus 11 sends a document password input by the user, the image forming apparatus 11's IP address, and MAC address etc (step S210). The second image forming apparatus 12 receives the document password and the image forming apparatus 11's IP address, and MAC address etc. The image forming apparatus 12 compares the received document password with the document password in the data table 40 of the second image forming apparatus 12. If they are a match, then the second image forming apparatus 12 sends authorization of copying to the image forming apparatus 11. If they are not a match, then the second image forming apparatus 12 doesn't send an authorization to copy. The second image forming apparatus 12 stores the history of the transaction and the image forming apparatus IP address, and MAC address etc in the data table 40.

If the image forming apparatus 11 receives authorization (step S211: YES), then the image forming apparatus 11 copies the document and sends the transaction history to the second image forming apparatus 12. The second image forming apparatus 12 stores the history and the image forming apparatus IP address, and MAC address etc in the data table 40.

If the image forming apparatus 11 doesn't receive authorization (step S212: NO), then the image forming apparatus 11 doesn't copy the document.

According to an additional embodiment of the present invention, the user is able to input the department or user ID and password in addition to or instead of the document password (step S210). Then the second image forming apparatus 12 accesses the data table 40, specifically the department or user ID, and data table 50a or 50b. The second image forming apparatus 12 sends authorization of copying if the received ID and password are a match, and confirms the department or user of the right to copy. Although the data table 40 only stores the ID as the value of the ID 45 and the second image forming apparatus received the user ID and password, the second image forming apparatus can confirm the authorization by cross-checking table 50a, specifically the department value of 53a associated with the User ID.

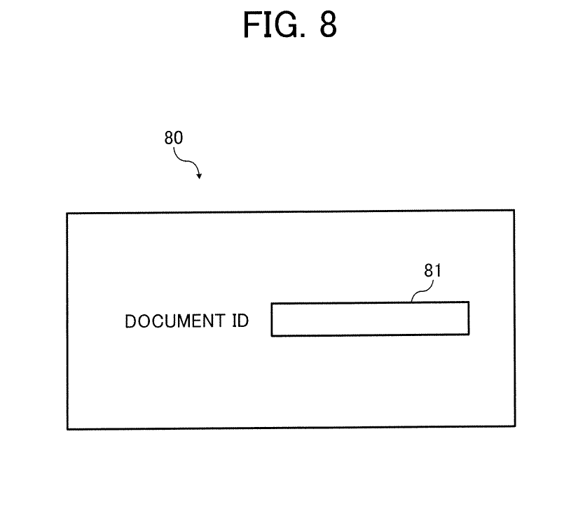

Users can modify a value of the data table 40 using the operating device 206 or the personal computer 13. FIG. 8 is an example of the user interface for modifying values of the data table 40. The user can access display image 80 if the user changes from a default mode to a modify mode at the operating device 206 or can input the ID address of the second image forming apparatus 12 using the keyboard connected to the personal computer 13. If the user inputs the document ID at box 81, the user can retrieve display image 300 with present values. Then the user can modify the values in the data table 40.

The present invention is not limited to these embodiments, but various variations and modifications may be made without departing from the scope of the present invention.

What is claimed is:

1. An image forming apparatus connected to a network, comprising:
a reading device configured to read a document having ID data;
a storage device configured to store a document data that is transmitted by the reading device;
an analyzing device configured to analyze the document data and to determine an image forming apparatus that formed said document using said ID data;
a communication device configured to transmit the ID data to the image forming apparatus found by the analyzing device; and
an image generating device configured to generate the document data on a media when said communication device receives an authorization to copy sent by the image forming apparatus that is found by said analyzing device.

2. The image forming apparatus as claimed in claim 1, further comprising:
an ID data generating device configured to generate ID data when the image generating device generates an image on a media, and to add said ID data to said image data.

3. The image forming apparatus as claimed in claim 2, further comprising:
an authorization device configured to decide whether to authorize copying of the document based on a predetermined standard when said communication device receives said ID data.

4. The image forming apparatus as claimed in claim 3, wherein:
said storage device is configured to store results of authorization decisions by the authorizing device.

5. A method of forming an image in an image forming apparatus, comprising:
reading a document that has ID data;
storing document data including the ID data;
analyzing the document data;
determining an image forming apparatus that formed said document using said ID data;
transmitting said ID data to an image forming apparatus found by said determining step; and
generating said document data on media when the image forming apparatus receives authorization to copy sent by the image forming apparatus that is found during said analyzing step.

6. The method as claimed in claim 5, further comprising the step of:
generating ID data when said image forming apparatus generates image on the media; and
adding said ID data to said image data.

7. The method as claimed in claim 6 further comprising the step of:
deciding whether to authorize copying of the document based on a predetermined standard when said image forming apparatus receives the ID data.

8. The method as claimed in claim 7 further comprising the step of:
storing results of the decision step.

9. The method as claimed in claim 5, further comprising the step of generating the document data on the media when the image forming apparatus receives authorization using a predetermined protocol.

10. An image forming apparatus connected to a network, comprising:
means for reading a document having ID data;
means for storing document data that is transmitted by said reading means;
means for analyzing said document data and determining an image forming apparatus that formed said document using said ID data;
means for transmitting said ID data to an image forming apparatus that is found by said analyzing means; and
means for generating said document data on media when said communication means receives authorization to copy from the image forming apparatus that is found by said analyzing means.
